(19) United States
(12) Patent Application Publication
(10) Pub. No.: US 2003/0149881 A1
(43) Pub. Date: Aug. 7, 2003

(54) Apparatus and method for securing information transmitted on computer networks

(75) Inventors: Manish Patel, Edison, NJ (US); Bharat Patel, East Brunswick, NJ (US); Vinay Kumar Mahajan, New Delhi (IN)

Correspondence Address: Ralph W. Selitto, Jr., P.O. Box 1477, Edison, NJ, 08818-1477, US

(73) Assignee: Digital Security Inc.

(21) Appl. No.: 10/062,898

(22) Filed: Jan. 31, 2002

(51) Int. Cl. H04L 9/00

(52) U.S. Cl. 713/186

(57) ABSTRACT

A method for communicating confidential data over a computer network, such as the Internet includes encrypting the confidential data while the confidential data is in the control of a sender. The step of encrypting includes mixing the confidential data with biometric data to produce encrypted data. The encrypted data is then sent over a communication link to a receiver. The encrypted data is de-encrypted while the encrypted data is in the control of the receiver by separating the biometric data from the confidential data. Voice signatures are convenient forms of biometric data and may be used for the dual purpose of encrypting the data to be sent and serving as a key to be matched by the second entity to gain access to the data, i.e., to allow de-encryption. The further step of converting the encrypted data from a first format to a second format, e.g., wave file format, may provide additional security and requires the reconversion by the second entity in order to de-encrypt. Additional key data may be generated and combined with the confidential data and/or biometric data in accordance with a predetermined algorithm to create a second level of encryption and which is de-encrypted by a reverse algorithm.

### FIELD OF THE INVENTION

The present invention relates to apparatus and method for encrypting data transmitted or accessible on computer networks to prevent unauthorized access to the data. More particularly, the present invention utilizes biometrics to limit user access to data transmitted and/or available on a network, such as the Internet.

### BACKGROUND OF THE INVENTION

The communication and availability of confidential information, such as credit card numbers, medical records, financial information, trade secrets, proposals, software source code, insurance claims, etc. on computer networks, in particular, the Internet, requires the prevention of unauthorized users from accessing and using the confidential information. In addition to the use of passwords and access codes to limit accessibility to data stored on host computers, various encryption techniques have been employed to prevent unauthorized access to data that is transmitted over the Internet from one computer to another. Encryption is required because hackers can monitor and redirect data transmitted over the Internet. Various encryption techniques are known and many have been cracked by hackers who discern methods for de-encryption.

Controlling access to data by the provision of an access code or password is subject to hacking and is also inconvenient for users who are required to remember arbitrary passwords and access codes. In response to these limitations, biometrics are becoming increasingly popular tools for controlling access, both to information and/or to secured areas. Biometrics derive an “access code” from an individual's unique anatomical shape and dimensions, for example, with respect to the individual's fingerprints, iris or the frequency compositions and patterns of the voice. In biometrics, the “key” is inherent and unique to the individual, and is always with the individual, therefore memorization of a complex password is unnecessary. In addition, a fingerprint or voice is a source of a potentially unlimited number of reference points, depending upon the resolution with which it is inspected and measured. While the measurement of anatomical features, e.g., fingerprint scanning or iris scanning is technologically possible using personal computers and associated peripherals, the hardware implementation is complex and expensive. In contrast, the hardware utilized for voice analysis are common features on most modern personal computers, which include microphones, speakers and sound processing circuits. A number of methods have been developed for generation of speech samples/voiceprints (voice signatures) of speakers. A number of them are based on a single template, such as Dynamic Time Warping (DTW), Gaussian Mixture Models (GMM) or Hidden Markov Models (HMM). These are distortion/statistically-based pattern classifiers that take the measurements from the speaker only. Other methods use Neural Tree networks (NTN).

An NTN is a hierarchical classifier that incorporates the characteristics of both decision trees and neural networks. Using discrimination training this method learns to contrast the voice of the speaker (member) from the voice of a pool of antispeakers (other members) with similar voice patterns.

U.S. Pat. No. 4,957,961 describes a neural network, which can be rapidly trained to reliably, recognize connected words. A dynamic programming technique is used in which input neuron units of an input layer are grouped in a multi-layer neural network. For recognition of an input pattern, vector components of each feature vector are supplied to respective input neuron units on one of the input layers that is selected from three consecutively numbered input layer frames. An intermediate layer connects the input neuron units of at least two input layer frames. An output neuron unit is connected to the intermediate layer, An adjusting unit is connected to the intermediate layer for adjusting the input-intermediate and intermediate-output connections to make the output unit produce an output signal. The neural network recognizes the input pattern as a predetermined pattern when the adjusting unit maximizes the output signal. About forty times of training are used in connection with each speech pattern to train the dynamic neural network.

It has been found that a reduced set of cepstral coefficients can be used for synthesizing or recognizing speech. U.S. Pat. No. 5,165,008 describes a method for synthesizing speech in which five cepstral coefficients are used for each segment of speaker independent data. The set of five cepstral coefficients is determined by linear predictive analysis in order to determine a coefficient weighing. The coefficient-weighing factor minimizes a non-squared prediction error of each element of a vector in the vocal tract resource space. The same coefficient weighing factors are applied to each frame of speech and do not account for the spectral variations resulting from the effect of non-format components.

As per S. Furui, “Cepstral Analysis Technique For Automatic Speaker Verification” IEEE Transactions On Acoustics, Speech, and Signal processing, ASSP-29: 254-272, April 1981, a reference template is generated from several utterances of a password during testing. A decision to accept or reject the speaker claimed identity is made by whether or not the distortion of the speaker's utterances falls below a predetermined threshold. This is the DTW technique. Another technique using Hidden Markov Models (HMM) is described in J.J. Naik “Speaker verification over long distance telephone lines”, Proceeding ICASSP 1989. As outlined above, a variety of speech analysis and differentiation techniques are known. In addition, the computer hardware for utilizing those techniques is common and relatively inexpensive. Accordingly, improved encryption techniques and data access based upon voice biometrics would be desirable.

### SUMMARY OF THE INVENTION

The problems and disadvantages associated with the conventional techniques and apparatus utilized to communicate confidential data are overcome by the present invention which includes a method for communicating confidential data from a sender to a receiver wherein the confidential data is encrypted while in the control of the sender. The step of encrypting includes mixing the confidential data with biometric data to produce encrypted data. The encrypted data is then sent over a communication link to the receiver. The encrypted data is de-encrypted while the encrypted data is in the control of the receiver by separating the biometric data from the confidential data.

### BRIEF DESCRIPTION OF THE FIGURES

For a better understanding of the present invention, reference is made to the following detailed description of an exemplary embodiment considered in conjunction with the accompanying drawings, in which:

FIG. 1 is diagrammatic view of a computer network and associated computer system configurations on which the present invention may be practiced;

FIGS. 2A through 2H are flow charts illustrating the processing utilized in the present invention;

FIG. 3 is a diagrammatic depiction of the processing performed by the embedding step of the present invention; and

FIG. 4 is a diagrammatic view of the de-embedding process performed by the present invention.

### DESCRIPTION OF THE PREFERRED EMBODIMENTS

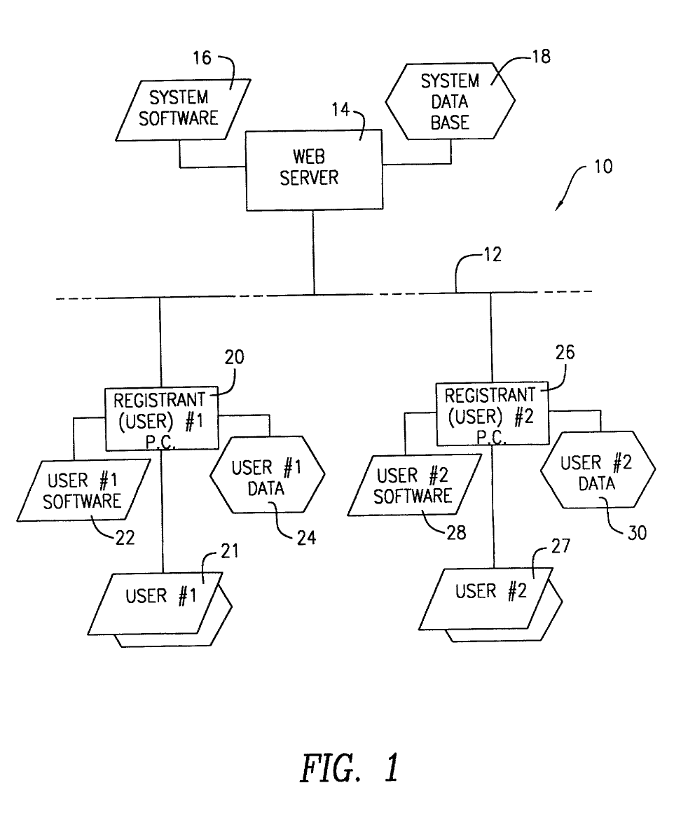

FIG. 1 shows a computer/network system 10 which will support the apparatus and method of the present invention and includes a network 12 for connecting various individual computers 14, 20, 26 for communication therebetween. While the Internet is an exemplary network 12, the present invention is applicable for use on any sort of computer network, such as a computer network 12 that is resident within a private corporation or a governmental entity. A web server 14 is programmed with system software 16 and has system data base 18 available to it as further described below. The data base 18 has various files, e.g., for storing voice signatures and for storing data files to be communicated between users 21, 27. A plurality of user PCs 20, 26 are connected to the network 12 and each has locally resident system software 22, 28 and system data 24, 30 for performing the processes of the present invention. The web server 14 serves as a central administrator that provides access to and maintains the system software 16 and data base 18,serving a plurality of registrant PC's, for example, 20, 26.

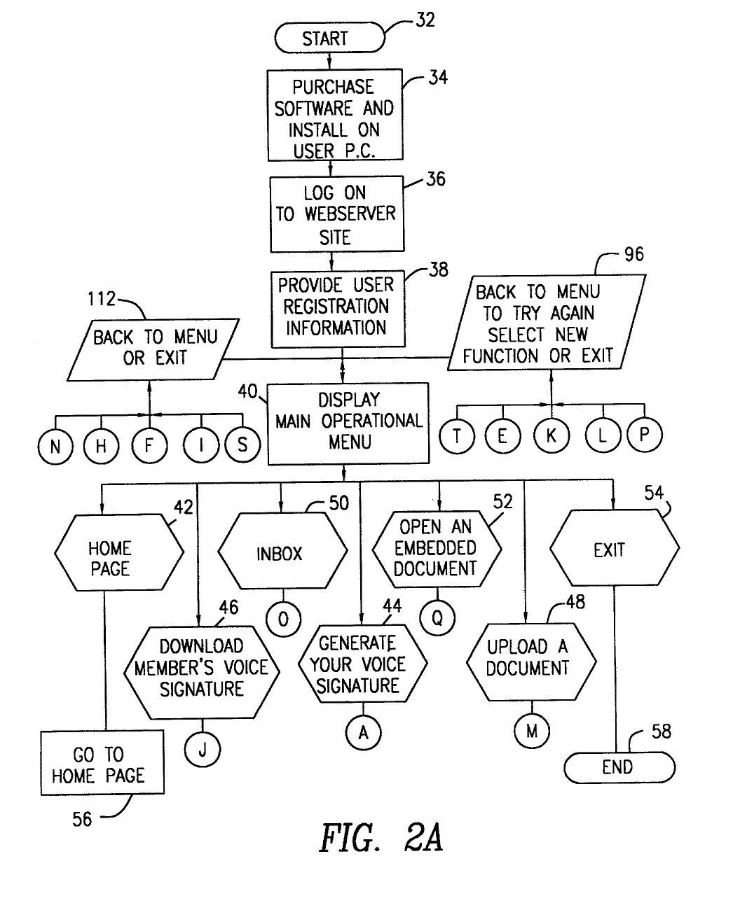

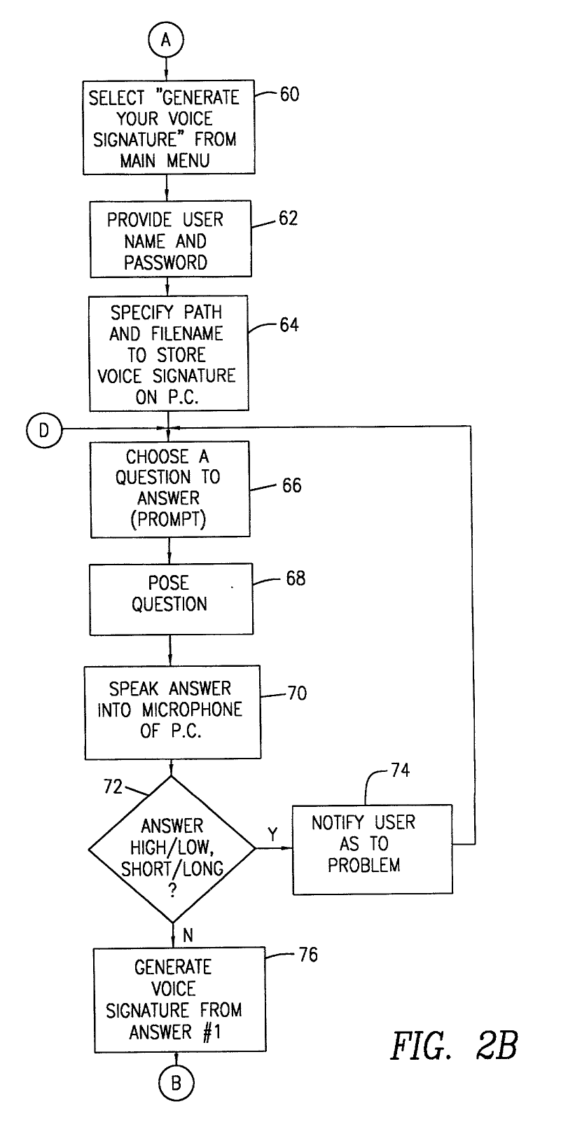

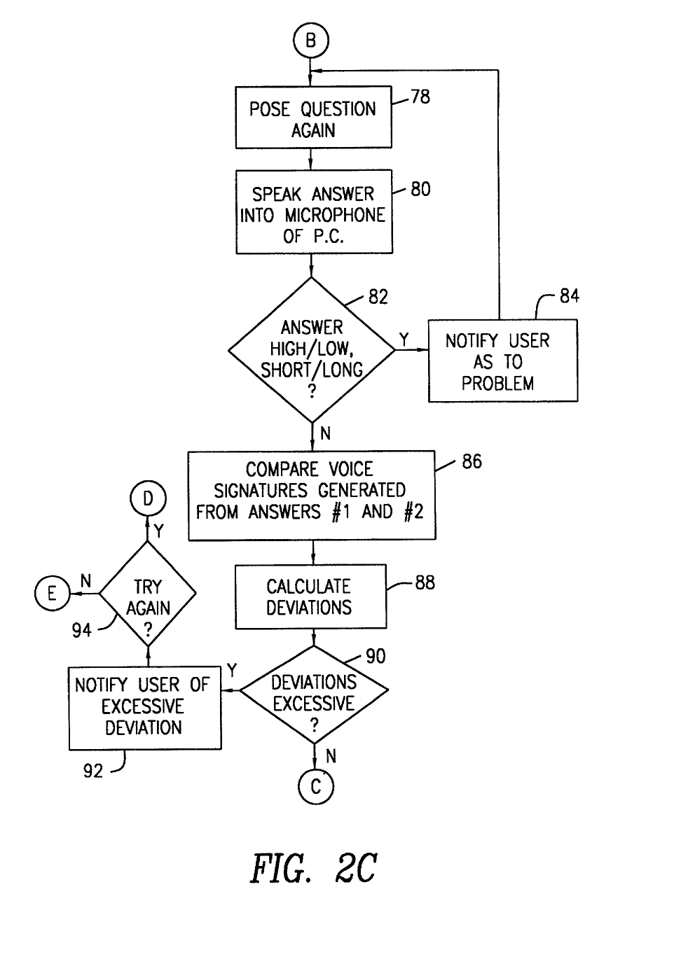

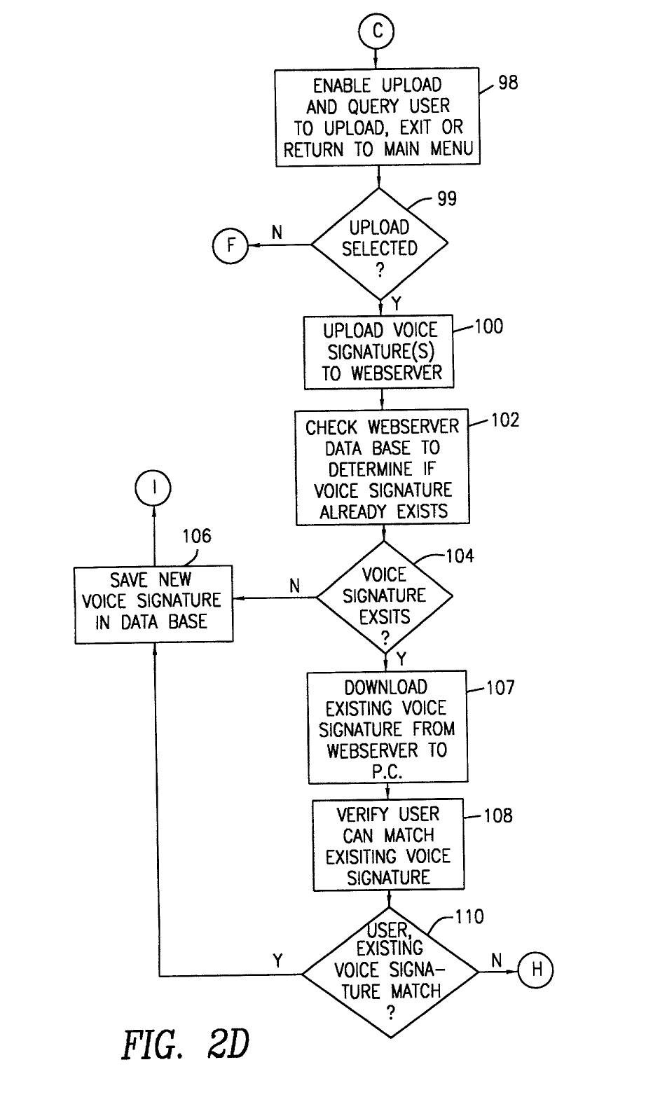

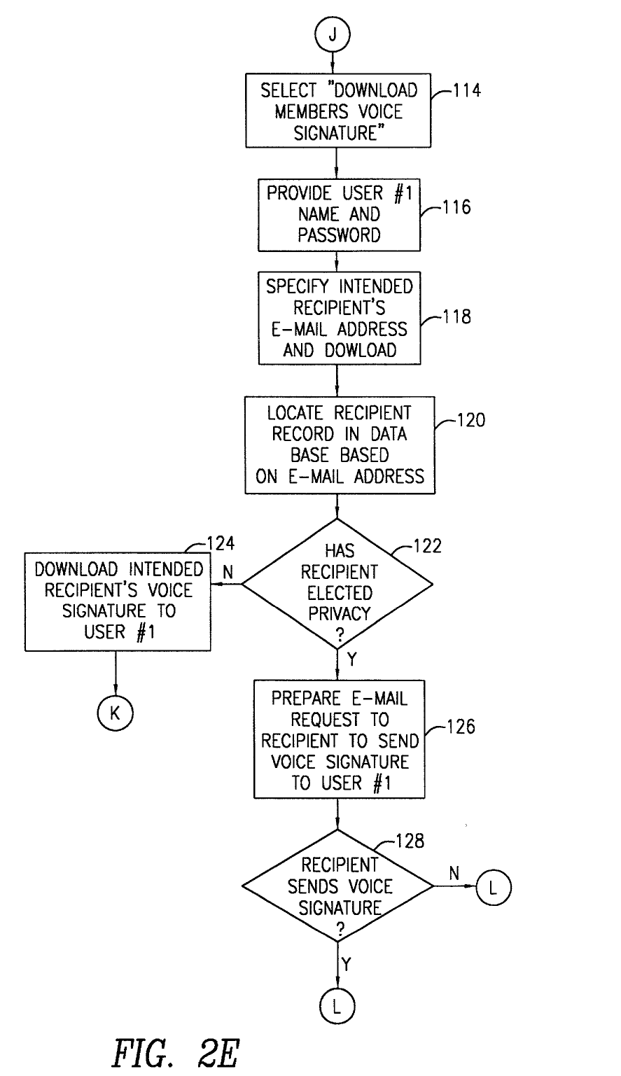

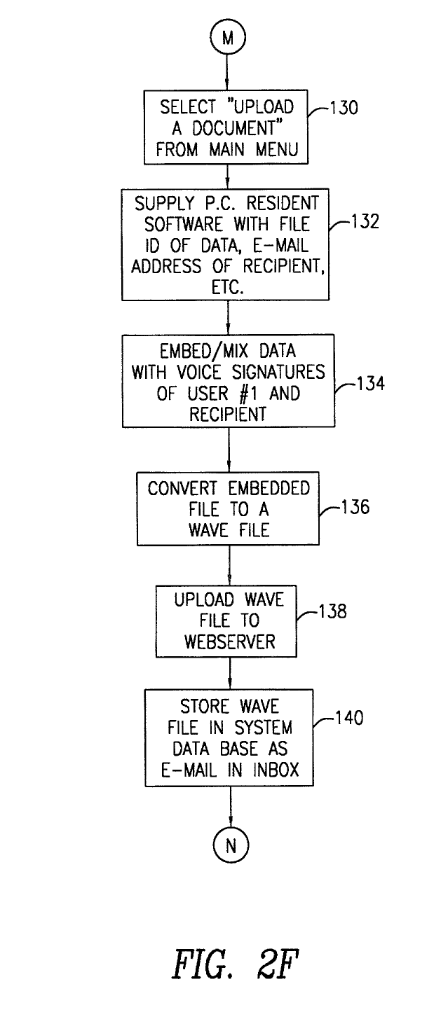

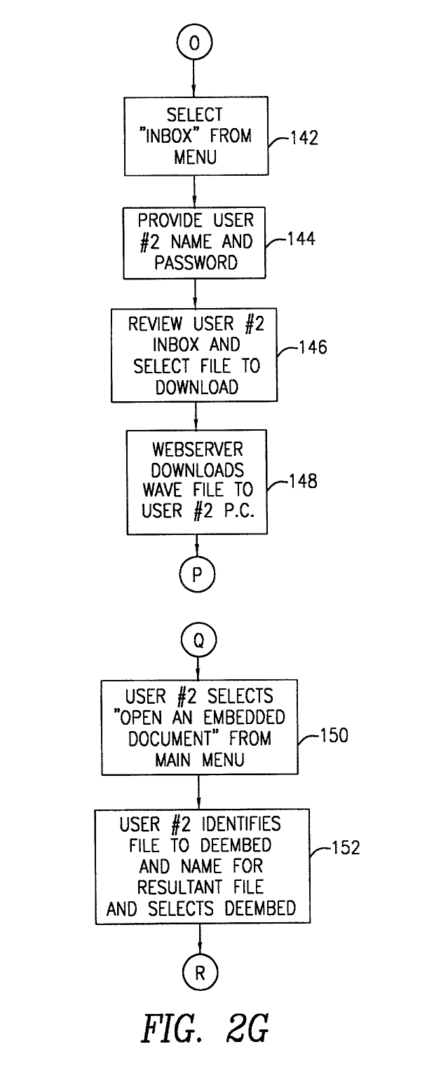

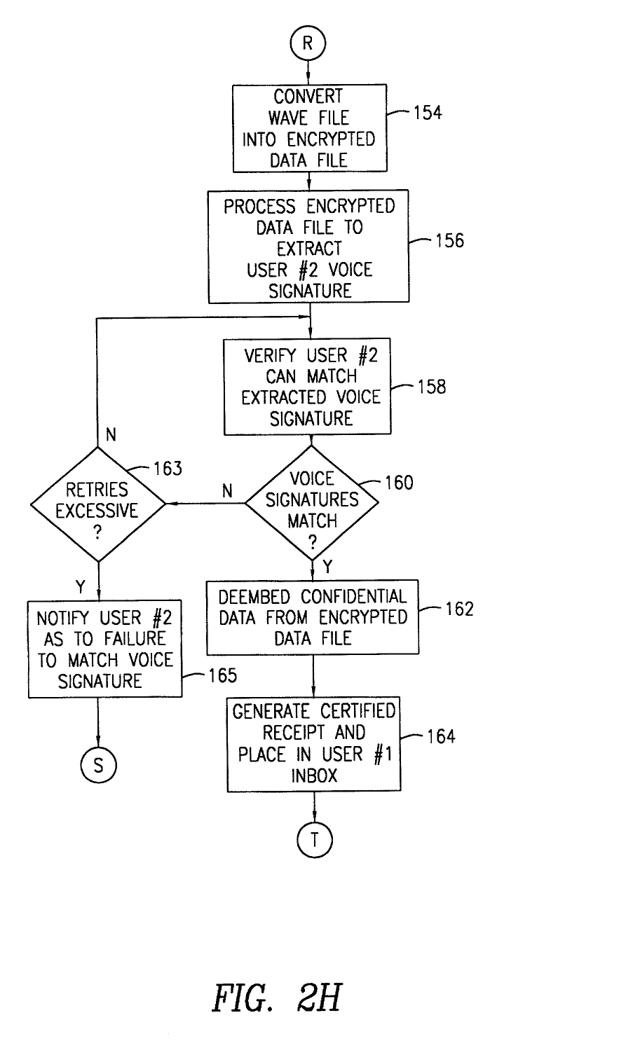

FIGS. 2A through 2H illustrate the processing flow and functionality of the system 10, primarily from the viewpoint of a user 21, 27, but also from the perspective of the web server 14 as it interacts with the users 21, 27 over the network 12. After the start point 32, all users, e.g., 21, 27, will each purchase and install 34 the software 22, 28 for running on the registrant's PCs 20, 26. The users 21, 27 log 36 onto the web server 14 and provide 38 the user registration information requested by the web server 14. Exemplary information would include: (1) user name; (2) email address; (3) password (which is retyped for verification); (4) first name; (5) last name; (6) a secret question to be posed by the system to the user; and (7) the corresponding secret answer that the user would utilize in responding to the secret question. The secret answer is effectively a second password but also functions as a speech sample as described below. The user/registrant is queried as to whether he wishes to make his voice signature available to other registered users (public). As will be described below, the selection of making a voice signature public will enable any member of the registered public to email the registrant secure, encrypted data. By selecting a private voice signature, only those persons who receive specific approval from the intended recipient (by emailing the intended recipient's voice signature to the proposed sender) will be able to transmit the secured data through the web server 14 to the intended recipient. This will be explained further below.

Assuming the registrant has provided the information required by the registration process 38 conducted on the web server 14, the web server 14 then displays 40 a main operational menu. The operational menu has selections 42, 44, 46, 48, 50, 52, 54 which are listed sequentially in an order which mimics the typical chronological flow of processing encountered when using the system for transmitting data in a secure manner over the network 12. More particularly, the main menu includes the following selections: “Home page” 42, “Generate your voice signature” 44, “Download member's voice signature” 46, “Upload a document” 48, “Inbox” 50, “Open an embedded document” 52, and “Exit” 54. Selection of “Home page” 42 returns 56 the user to the home page present on the web server 14. Selection of “Exit” 54 from the main menu will cause the program to end 58. The basic processing utilized for transmitting data from a first registered user, e.g., 21, to a second registered user, e.g. 27, starts with the selection “Generate your voice signature” 44. This is a preliminary step but it can be repeated subsequent to registration if the resultant voice signature is anomalous or otherwise proves to create an impediment or inconvenience. One of the purposes of generating the user's voice signature 44 is to provide the special biometric key that the user must reproduce at the time of opening a secure document (or gaining access to the system for performing some other function) as shall be seen below. The system 10 requires each user to generate their own voice signature and to store their voice signature on the system data base 18. When a secure document is transmitted from a first user to a second, the second user's voice signature is retrieved by the first user from the system data base 18 and incorporated into the transmitted document to encrypt it. The encrypted document is then forwarded to the second user. In order to de-encrypt the document, the second user must dynamically supply his voice signature which is compared to the voice signature embedded in the document transmitted by the first user. If a match occurs, the document is de-encrypted to allow the second user, the recipient, to view the document. If there is no match, then the document remains encrypted. In this manner, the recipient's voice signature is a biometric key. In order for all users to have the capacity to send and receive data, the system requires all users to generate their voice signatures. In the example to follow, the first user is the sender of the document and the second user is the receiver. However, as stated above, both users can send and receive.

Further in overview, after a user, e.g., 27 registers and generates their voice signature which is uploaded to the web server 14 and stored on the system data base 18, another user, for example 21, may select “Download member's voice signature” 46 in order for the PC resident software 22 to mix it or embed it in a document to be transmitted over the Internet 12 in a secure fashion. The system software 22 on the user's PC 20 enables the user 21 to mix the downloaded voice signature with the confidential data and then the resultant mixed file is uploaded 48 to the web server 14 where it is stored in the system data base 18 in the form of email with or without attachments. When the second registered user 27 (the intended recipient) checks his Inbox 50 he can observe the existence of the encrypted file therein. The recipient user can then retrieve the email from the Inbox and then proceed to de-encrypt (de-embed) the encrypted document 52 to read the confidential data transmission. Reviewing the foregoing process then, one can see that the start of the basic processing flow is to register, (to purchase and install the software on the user PC 34, log on to the web site 36 and provide the user registration information, passwords, etc. 38). Upon display 40 of the operational main menu, the user generates 44 his voice signature and then may proceed to utilize the voice signatures of others to transmit documents to then by downloading 46 the intended recipient's voice signature. The recipient's voice signature is mixed with the confidential data using the system software, for example 22, resident on PC 20 and then uploaded 48 to the web server 14 for storage in the email system of the system data base 18. Upon checking 50 his Inbox, the recipient 27 downloads the encrypted document to his PC 26, and utilizing the user software 28 resident thereon opens 52 the embedded document and stores the de-encrypted data.

FIG. 2B shows the more specific processing which occurs in the process of generating a voice signature. More specifically, the user selects 60 “Generate your voice signature” and provides 62 their user name and password. The user then specifies 64 the path and file name to store the voice signature on their PC. The software used in the process of generating a voice signature may be resident on the user PC, for example 20 or on the web server 14. The resultant voice signature will be stored on the user PC 20 in data base 24. The user may specify 66 a question to answer. This may be the same question specified 38 during the process of registration. The question and answer can be of a type that is not readily known or could not be guessed by an unauthorized user. The software then poses 68 the question selected 66 to the user. As noted above, the PCs 20, 26, have sound processing circuitry and peripherals (multimedia equipment), e.g., microphones and speakers that permit the user PC to hear an audible question and to enunciate a verbal response which is captured by the computer. Accordingly, the user speaks 70 into the microphone of the PC the answer to the question posed in step 68. The specific answer generated at step 70 is going to be used as the speech sample that is processed by the system software, either 16 or 22, and from which a voice signature will be generated. The software 16 or 22 analyzes 72 the speech sample provided at step 70 to determine if it is of sufficiently long duration or if it is too long and/or whether it is of at the appropriate volume. If any of this checking 72 indicates that the speech sample is outside acceptable parameters for generating a voice signature, the user is notified 74 as to the specific problem and the program then proceeds to allow the user to either choose a question again at 66 or just cause the question to be re-asked 68, allowing the user another opportunity to generate an appropriate voice sample. The software 22 then proceeds to generate 76 a voice signature from the speech sample resulting from the answer given at 70.

The generation of a voice signature from a speech sample and the verification of matching signatures in the present invention is preferably done in the following manner. The speech sample is generated by the speaker, by speaking a password/phrase in response to a specific question. The program for the generation and verification of voice signatures is preferably resident on the user's PC and uses a short-time average magnitude method to calculate Energy. The program then applies a Zero Crossing Rate. In this manner, the program detects beginning and end points of the given voice signal. The program normalizes the audio signal to avoid variation in the amplitude and then applies a Short Time Hamming window for smoothing frequency components.

The voice signature is then generated in the following steps: (1) Auto correlation coefficients are taken for the full length of the speech sample; (2) Linear predictive coefficients; and (3) Cepstral coefficients are obtained. Using the above sets of three coefficients (4) static parameters are generated; (5) For every 10 ms of the speech sample, the above parameters are taken; and (6) Delta Coefficients are obtained. Thus, Dynamic parameters are taken and stored. The foregoing static and dynamic parameters are stored as the voice signature. To compare two independently generated voice signatures, the deviations between the two corresponding sets of static and dynamic parameters are computed and must be within a specified range for the voice signatures to be considered a match.

Referring to FIG. 2C, the same question previously posed by the computer, e.g., 20 at 68 is posed again 78 and the user answers the same question with the same answer by speaking 80 into the microphone of the PC 20. The same preliminary analysis is performed 82 to determine whether the answer is a suitable speech sample. The user is notified 84 if it is not and given another opportunity to generate a suitable speech sample. As is conventional, this loop including decision 82 and function 84 will be monitored to ascertain if it has been traversed an excessive number of times and if so, will require the user to choose another question to answer at 66 and/or to exit the program. Assuming that the user has generated a suitable sample, a second voice signature is generated for the speech sample of the second answer and compared 86 to the first voice signature. Static distance is calculated from the first set of static parameters and those generated from the second speech sample. This process is repeated for the second set of parameters also. Dynamic Distances are calculated by applying the DTW (Dynamic Time Warping Algorithm) on both sets of dynamic parameters. Static and dynamic distances thus generated are compared and the deviation of the voice signatures is calculated 88 and compared with the respective predefined thresholds. If the deviations between the two voice signatures is excessive 90, the user is notified 92 of this condition and asked 94 if he would like to try generating suitable speech samples again. If yes, he is returned to the original prompt to choose a question at 66 or if not he is directed back to the main menu 40 (See FIG. 2A) to allow the user to exit 54 the program. Alternatively, repeated failures can automatically trigger exiting the program or provide the user with the option of exiting the program without requiring a return to the main menu to select exit 54. This is particularly appropriate in those situations where the software has determined that an unauthorized user is attempting to infiltrate the system.

Assuming that the voice samples generated have corresponding voice signatures without excessive deviations, the processing continues on FIG. 2D by enabling 98 the upload of the voice signature (either the first or the second one generated or an amalgam) and querying 98 the user to upload, exit or return to the main menu. If upload is selected 99, the voice signature is sent 100 via the Internet to the web server 14. The web server 14 upon receiving the uploaded voice signature, checks 102 the data base 18 to determine if a voice signature already exists for this particular user. If the voice signature does not exist 104, the new voice signature is simply saved 106 in the data base 18. An exemplary file structure for storing voice signatures includes the fields: (1) email address; (2) password; (3) voice signature data field; and (4) public or private email indicator. In the event that the voice signature is determined at 104 to already exist in the data base 18, then the existing voice signature in the data base 18 is downloaded 107 to the PC, e.g., 20 and the user is queried to determine if he can match the existing voice signature by way of a spoken response to a predetermined question. If the user can match 110 the existing voice signature, then the new voice signature can be saved 106 in the data base 18, overwriting the existing voice signature. If the registrant cannot match 110 the existing voice signature, then the user is redirected back to the main menu 40 or the program or the program automatically terminates.

In order to exercise the next logical function of the system 10 it has to be assumed that at least two individuals have registered with the system 10 and have uploaded their voice signatures. In this context, if one registered user seeks to send data to another registered user in a secure manner over the network 12, the sender selects “Download member's voice signature” at the main menu 40 at step 114 (See FIG. 2E). It should be appreciated that the individual member whose voice signature is downloaded is the intended recipient. In order to download the voice signature of the intended recipient, the sender must provide their name and password to the system web server 14 at step 116. Assuming that the sender provides the correct name and password, he is then allowed to specify 118 the intended recipient's email address which is then utilized as the key for searching for the intended recipient's voice signature in the data base 18 of the web server 14. The recipient's record in the data base 18 is located 120 based upon the email address. At the time of obtaining the correct record, namely for the intended recipient, the record is checked 122 to see if the public or private field indicates privacy. If the intended recipient has not indicated privacy, then the intended recipient's voice signature is downloaded 124 to the sender's PC. In the event that the intended recipient has elected privacy 122, the system software 16 automatically prepares 126 an email request to the recipient to send his voice signature to the sender i.e., by providing authorization to the web server 14 or by emailing a copy stored on his PC. Regardless whether the recipient sends 128 the voice signature or declines to send it, control returns to the main menu 40 to allow the sender to exit or select another function. Once the sender comes to possess the voice signature of the recipient, the sender can display 40 the main operational menu and select “Upload a document” 48 from the main menu.

FIG. 2F illustrates the processing associated with selection 130 of option 48. Upon selecting 130 “Upload a document” from the main menu, the PC resident software, e.g., 22 requests 132: (1) the file identification of the data to be sent, i.e., the file name and its location on the sender's PC 20; (2) the email address of the recipient; (3) the file name for the recipient's voice signature; (4) the file name for the sender's voice signature; and (5) the file name for the resultant embedded/encrypted file. The user may also indicate whether he wishes to receive a receipt from the intended recipient upon receipt of the encrypted document. Having provided the foregoing information, the system software 22 on the user's PC 20 then proceeds to mix or embed 134 the data file to be transferred with the recipient's voice signature, as well as, the voice signature of the sender to create a composite encrypted data file. This mixing/embedding step 134 may be compound to increase the difficulty of unauthorized de-encryption. For example, each data component, i.e., the data file and the voice signatures, may be pre-processed by shifting, adding a key code, etc., prior to being mixed together in a predetermined manner to create an encrypted file. This process of mixing/embedding is described further below. After mixing the data to create the encrypted data file at 134, the encrypted data file is then converted 136 to a wave file. The wave file is uploaded 138 to the web server 14. The web server 14 then stores 140 the wave file in the system data base 18.

The intended recipient will check his Inbox (which is part of the data base 18) periodically by signing on to the web server 14 and selecting 142 “Inbox” from the operational menu as illustrated in FIG. 2G. Upon selection 142 of “Inbox”, the intended recipient provides 144 his name and password. This permits the recipient to review 146 his Inbox and to select any files in the Inbox to download. Upon selecting a file to download, the web server 14 downloads 148 that wave file to the recipient's PC, e.g., 26. The intended recipient 27, having the encrypted file in wave file format present on the PC 26, can then select 150 “Open an embedded document” from the main menu. The recipient identifies 152 the file on his PC to de-embed, that is to convert from wave file format to encrypted file to an unmixed file and further provides the name for the resultant file and then selects de-embed from the de-embed screen. To repeat, the de-embed screen queries the recipient with three fields to be filled, namely, (1) the data file to be de-embedded; (2) the path to that data file; and (3) the name of the resultant de-encrypted file. Having provided that information at step 152, the program can then proceed to convert the wave file into an encrypted data file at step 154 (FIG. 2H). The encrypted data file is then processed to extract 156 the recipient's voice signature which was previously mixed into the file before it was uploaded by the sender, i.e., by reversing the encryption processes performed at step 134 relative to the recipient's voice signature. Having extracted 156 the recipient's voice signature, the program (either 22 and/or 16) then verifies that the recipient can extemporaneously match 160 the extracted voice signature. This process of verification is just like that which was described previously, e.g., at step 110. The question previously specified by the recipient 27 is posed to the recipient 27 and he responds with a spoken answer generating a speech sample that is then converted to a voice signature. The dynamically produced voice signature at step 158 is compared at step 160 to the voice signature extracted from the encrypted data file produced by step 156. If the voice signatures match, then the confidential data in the encrypted data file is fully de-embedded or unmixed 162 such that the data file which was intended to be sent by the sender is readable by the intended recipient and is stored in the location specified by the recipient when filling out the de-embed screen. It should be appreciated that all the various screens requiring the location of data files and the naming of the files provide the commonly used Browse function to assist the users in naming and storing files. In the event that the recipient cannot match the voice signature provided in the encrypted data file at step 160, he is allowed to retry the process of answering the posed question and comparing 158 the resultant voice signature generated from the answer to the voice signature present in the encrypted data file. This process is repeated for a predetermined number of times which are counted at step 163 until the retries are found to be excessive, whereupon the intended recipient, is notified 165 as to his failure to match the voice signature in the encrypted file. In that case, the data will not be released to that user. The program then returns to the main menu 40 or automatically exits. Assuming that the confidential data was successfully de-embedded at step 162 and that the sender indicated that he desired to receive a receipt upon the successful de-embedding of the file, a certified receipt is generated 164 by the web server 14 and is placed in the sender's Inbox. The certified receipt may be in the form of a simple email or may be in the form of an encrypted data transmission which includes the voice signature of the sender, thereby requiring the sender to provide a voice sample to de-encrypt the certified receipt. The program may contain additional security measures, such as, periodic checking of time stamped secure emails for purging or an automatic file delete that deletes a secure email from a user's PC upon the user failing to provide successful voice verification after a predetermined number of tries (self destructive files).

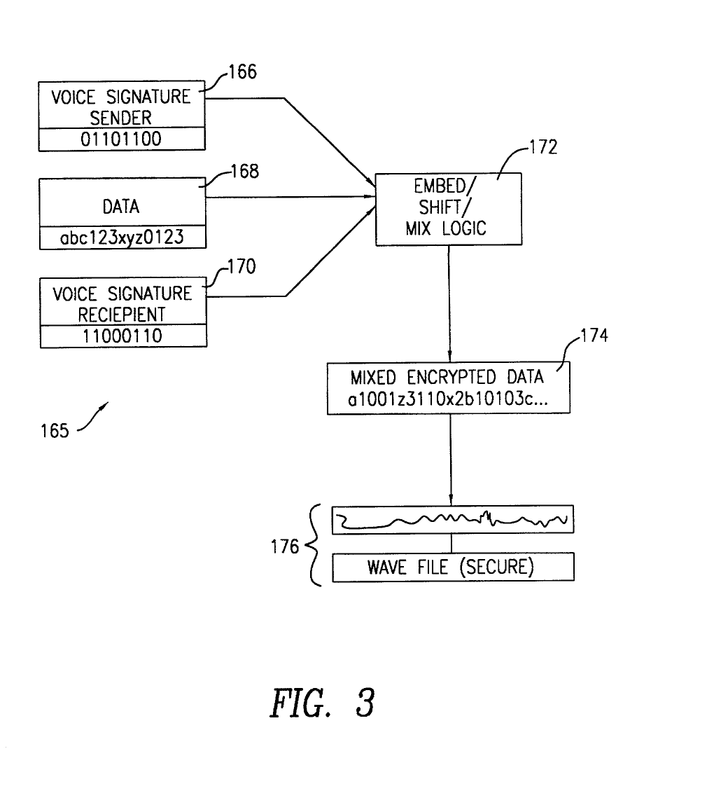

FIG. 3 diagrammatically illustrates the process of mixing/embedding 165 the voice signatures of the sender 166, the data to be sent 168 and the recipient's voice signature 170. This data is optionally embedded with a key code, shifted or otherwise pre-processed, then mixed 172 to produce a mixed encrypted data file 174. Data file 174 is converted to a wave file format 176 prior to transmission over the Internet.

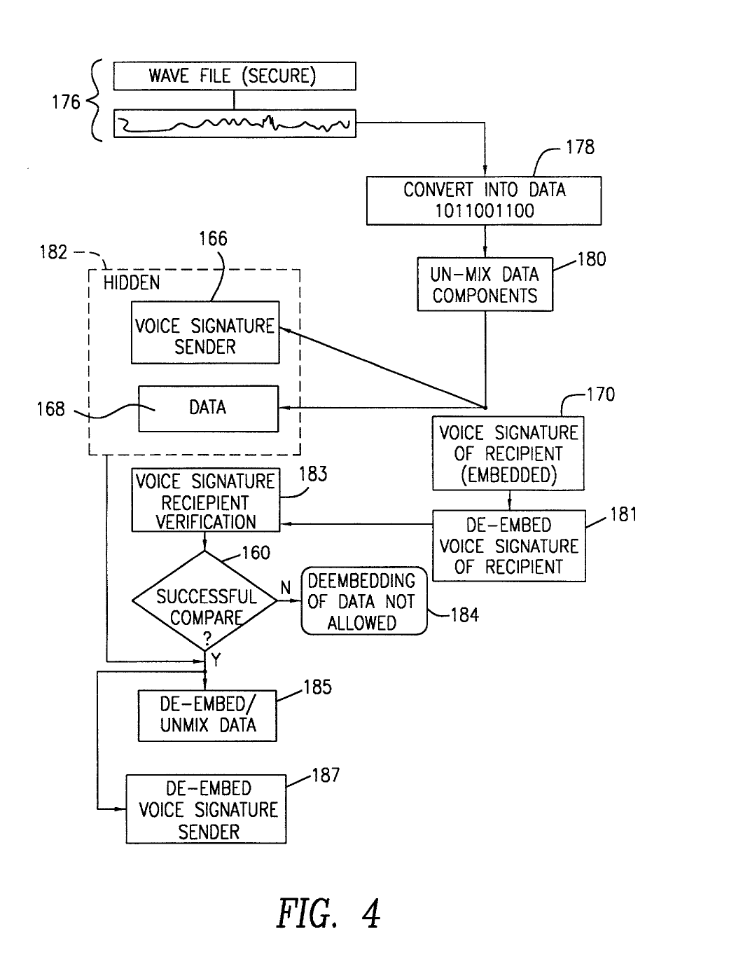

FIG. 4 shows the de-embedding process wherein the wave file format 176 is downloaded from the Internet to the recipient's PC, e.g. 26, and converted 178 from a wave file 176 to an encrypted data file. The encrypted data file is subjected to unmixing 180 to produce two components, namely, a hidden component 182 including the data 168 and the voice signature of the sender 170 which is optionally embedded with a key code or otherwise encrypted. The recipient's voice signature is de-embedded 181 and then verified 183 by comparison to a voice signature generated from a speech sample provided by the recipient. If the previously recorded reference voice signature 170 and the extemporaneously generated voice signature successfully compare 160 then the data is unmixed and de-embedded 185, as is the voice signature of the sender 187, such that the data 168 is visible to the recipient whereby the recipient receives the intended transmission. If the compare 160 is not successful, than de-embedding is not allowed 184 and the data remains mixed with the sender's voice signature 166 in a hidden encrypted file component 182.

The process of embedding 134 and de-embedding 156, 162 may be carried out in an unlimited number of ways. An exemplary methodology in accordance with the present invention is shown in the following examples.

### EXAMPLE NO. 1

### Embedding Data (Text File)

Step 1

Data=A=01000001

Step 2

Receivers Voice Signature (RVS)=B=01000010

Senders Voice Signature (SVS)=C=01000011

Step 3

Calculate the embedding code, for example:

| | |
|---|---|
| username | sm@hotmail.com |
| password | abc |

Calculation for embedding code:

| | |
|---|---|
| ASCII Code for s | 115 |
| ASCII Code for m | 109 |
| ASCII Code for a | 97 |
| ASCII Code for b | 98 |
| ASCII Code for c | 99 |
| Total | 518 |

Total of numeric figures will be 5+1+8=14

Again the Total of numeric figures will be=1+4=5

Do this calculation until the result is a numeral from 1 to 9

In this example, 5 is the embedding code.

Step 4

After applying (adding) embedding code

Data=A=01000001

will be converted to

Data=F=01000110

and

RVS=B=01000010

will be converted to

Embedded RVS=G=01000111

and

SVS=C=01000011

will be converted to

Embedded SVS=H=01001000

Step 5

Secure Data File (.wav) will be:

| Voice Header | Embedded RVS | Embedded SVS | Embedded Data |
|---|---|---|---|
| 44 Bytes | 01000111 | 01001000 | 01000110 |

Step 6

If you open this Secure Data File in Windows you will get a Sound wave form.

### EXAMPLE NO. 2

### De-Embedding Data

Step 1

First remove the voice header.

| [symbol] | Embedded RVS | Embedded SVS | Embedded Data |
|---|---|---|---|
| 44 Bytes | 01000111 | 01001000 | 01000110 |

Step 2

Apply (subtract) de-embedding code (which is same as embedding code generated earlier-in this case 5) to get both(RVS SVS).

Embedded RVS=G=01000111

will be converted to

RVS=B=01000010

and

Embedded SVS=H=01001000

will be converted to

SVS=C=01000011

Step 3

Voice verification of RVS (Receiver's voice signatures) for de-embedding data by voice verification software.

Step 4

Apply de-embedding code to get data after voice verification

After applying embedding code

Embedded Data=F=01000110

will be converted to

Data=A=01000001

Step 5

Data is available for the user.

We claim:

1. A method for communicating confidential data from a sender to a receiver, comprising the steps of:
(A) encrypting the confidential data while the confidential data is in the control of the sender, said step of encrypting including mixing the confidential data with biometric data to produce encrypted data;
(B) sending the encrypted data over a communication link to the receiver;
(C) de-encrypting the encrypted data while the encrypted data is in the control of the receiver by separating the biometric data from the confidential data.

2. The method of claim 1, wherein the biometric data includes first biometric data relating to the receiver and further including the steps of:
(D) isolating the first biometric data from the encrypted data after said step of sending;
(E) generating second biometric data relating to the receiver; and
(F) comparing the first biometric data to the second biometric data to determine if there is a predetermined level of similarity therebetween, said steps of isolating, generating and comparing being conducted prior to said step of de-encrypting, with the execution or non-execution of said step of de-encrypting being dependent upon whether the predetermined level of similarity is present.

3. The method of claim 2, wherein said step (A) of encrypting includes mixing an additional data component with the confidential data and the first biometric data to produce the encrypted data, the additional data component and the confidential data remaining mixed after said step (D) of isolating the first biometric data, said step (C) of de-encrypting including separating the confidential data from the additional data component.

4. The method of claim 3, wherein the additional data component includes secret key data.

5. The method of claim 4 wherein the secret key data is combined with the confidential data via a logical/mathematical operation to encrypt said confidential data.

6. The method of claim 5, wherein the secret key data is combined with the confidential data before said step of mixing the confidential data with the biometric data in said step (A).

7. The method of claim 6, wherein the secret key data is de-combined from the confidential data after said step of separating the biometric data from the confidential data in said step (C).

8. The method of claim 7, wherein the secret key data is combined with the biometric data via a logical/mathematical operation to encrypt the biometric data and wherein the secret key data is de-combined from the biometric data after said step of separating the biometric data from the confidential data in said step (C).

9. The method of claim 8, further including the step of deriving the secret key data from a password via a predefined logical/mathematical formula.

10. The method of claim 5, wherein the secret key data is combined with the biometric data via a logical/mathematical operation to encrypt said biometric data.

11. The method of claim 3, wherein the additional data component is third biometric data.

12. The method of claim 11, wherein the third biometric data is a voice signature of the sender and further including the steps of:
(G) producing a reference voice signature for the sender; and
(H) storing the reference voice signature produced in step (G), prior to said step (A) of encrypting the confidential data.

13. The method of claim 3, wherein the first biometric data is a reference voice signature of the receiver and further comprising the steps of:
(I) producing the reference voice signature for the receiver;
(J) storing the reference voice signature produced in step (I); and
(K) communicating the reference voice signature of the receiver to the sender prior to said step (A) of encrypting the confidential data.

14. The method of claim 13, wherein the reference voice signature is stored on a server computer on the Internet and said step (K) of communicating includes downloading the reference voice signature from the server computer to a sender computer available to the sender.

15. The method of claim 14, wherein the reference voice signature is stored on the server computer in association with a flag indicating the necessity of the receiver giving prior authorization to the sender before receiving confidential data from the sender; and further including the step of checking the status of the flag prior to downloading the reference voice signature.

16. The method of claim 15, wherein said step (B) of sending includes uploading the encrypted data from the sender computer to the server computer; storing the encrypted data on an email system on the server computer; and downloading the encrypted data from the server computer to a receiver computer available to the receiver.

17. The method of claim 16, wherein the encrypted data is stored on the receiver computer for a predetermined time and then deleted automatically.

18. The method of claim 13, wherein said step (E) of generating includes deriving a voice signature from a speech sample given in real time by the receiver.

19. The method of claim 18, wherein said step (E) of generating includes the receiver speaking into an audio input of a computer to provide a speech sample, the speech sample being processed by the computer to derive the voice signature.

20. The method of claim 1, wherein the confidential data is in the form of a computer file residing on a first computer controlled by the sender, wherein the communication link is a computer network and said step of sending includes sending the encrypted data over the computer network to a second computer in the control of the receiver.

21. The method of claim 20 further including the step of:
(L) converting the encrypted data from a first file format to a second file format before said step (B) of sending.

22. The method of claim 21, wherein the second file format is a wave file format.

23. The method of claim 21, wherein said step (C) of de-encrypting includes reconverting the second file format to the first file format.

24. The method of claim 20, wherein the computer network includes the Internet and said step (B) of sending includes the transfer of the encrypted data from the first computer to a server computer and from the server computer to the second computer.

25. A method for encrypting and de-encrypting confidential data, comprising the steps of:
(A) Encrypting the confidential data by combining the confidential data with secret key data in accordance with a first predetermined logical/mathematical algorithm to produce data at a first level of encryption;
(B) Obtaining biometric data relating to a living creature;
(C) Mixing the biometric data with the data at the first level of encryption in accordance with a second predetermined algorithm to produce data at a second level of encryption;
(D) De-encrypting the data at the second level of encryption by separating the data at the second level of encryption with the biometric data and the data at the first level of encryption using the second pre-determined algorithm in reverse; and
(E) De-combining the confidential data and the secret key data using the reverse of the first predetermined logical/mathematical algorithm.

26. The method of claim 25, further comprising the step of converting the data at the second level of encryption from a file of a first format to a file of a second format after said step (C) of mixing and wherein said step (D) of de-encrypting includes reconverting from the second format to the first format prior to said step of separating.

27. The method of claim 26, wherein the second file format is a wave file format.

28. The method of claim 27, wherein said step (B) of obtaining includes generating a speech sample and deriving a voice signature from the speech sample constituting the biometric data, and further including verifying the voice signature after said step of separating by generating a second speech sample and deriving a second voice signature and comparing the voice signature of the biometric data to the second voice signature to determine a predetermined degree of similarity prior to said step of de-combining.
